(19) United States
(12) Patent Application Publication
(10) Pub. No.: US 2006/0068848 A1
(43) Pub. Date: Mar. 30, 2006

(54) System and method for load distribution between base station sectors

(75) Inventors: Joseph Shapira, Haifa (IL); Shmuel Miller, Doar-Na Oshrat (IL)

Correspondence Address: Anthony Castorina, Suite 207, 2001 Jefferson Davis Highway, Arlington, VA, 22202, US

(73) Assignee: Celletra Ltd., Yokneam Llit (IL)

(21) Appl. No.: 10/543,677

(22) PCT Filed: Jan. 28, 2004
(86) PCT No.: PCT/IL04/00080

§ 371 Date: Jul. 27, 2005

Related U.S. Application Data
(60) Provisional application No. 60/442,890, filed on Jan. 28, 2003.

(51) Int. Cl. H04M 1/00

(52) U.S. Cl. 455/562.1; 455/422.1

(57) ABSTRACT

A base station for a cellular telecommunications network is arranged to support a plurality of angular sectors. Each sector has a single dual column antenna, or two single column antennas, and each column is dual polarized such that each element in each column has a correspondingly polarized element in the other column. Thus the two pairs of correspondingly polarized elements form a phased array pair which is steerable together to form a narrow compound sector beam and steerable apart to form a wide compound sector beam.

### FIELD AND BACKGROUND OF THE INVENTION

The present invention relates to a system and method for load distribution between base station sectors and, more particularly, but not exclusively to a system and method for dynamic load distribution at a cellular base station.

Cellular communications systems are subject to ever increasing user demands. Current subscribers are demanding more services and better quality while system capacities are being pushed to their limits. The challenge, therefore, is to provide feasible and practical alternatives that increase the system capacity while achieving a better grade of service.

Typically, for each geographic cell, cellular communication systems employ a base station (BS) with an omni-directional antenna that provides signal coverage throughout the cell. One way to increase the communications capacity is to split the geographical cell into a plurality of smaller cells (i.e. cell-splitting) by deploying additional BSs within the cell, thereby increasing the number of frequencies or codes that can be re-used by the system in that area This cell-splitting can be both cost-prohibitive and the multitude of new antennas may be inhibited by municipal planning rules, zoning requirements and the like.

An alternative approach to improving system capacity and maintaining service quality is to angularly divide the geographic cells into sectors (i.e. sectorize) and deploy BS antennas that radiate directive beams to cover designated sectors. This focuses the transmitted signals to these sectors, and thus reduces the interference to other sectors, and at the same time reduces the interference received from other sectors, thereby increasing the capacity of the system.

Typical cellular network sites are not evenly loaded. Over 50% of the cells that reach a capacity limit in fact have only one sector that actually reaches its limit. 38% percent of the rest have two saturated sectors, and only 11% reach the limit in all sectors. Only the latter case can be termed a load-balanced cell. Such a non-uniform load pattern further changes over time, with user distribution and activity. The standard sectorization thus fails to effectively utilize the available network resources in these typical cases.

Coverage shaping by shaped narrow beams have been proposed and used to improve the system usage, for example U.S. patent application Ser. No. 10/470,467 to the present assignee. One method relies on a stack of narrow beams that is combined in a way to shape the pattern. The method is disclosed in U.S. patent application Ser. No. 09/347,844, published as 2003/0073463, to the present assignee. The sector orientation and width are thus controlled and loads can be balanced between sectors.

The signal transmitted in the cellular environment typically bounces from many objects, buildings, vehicles and the like, thus forming many replicas of a single signal arriving at the receiver from different directions and with different delays. The effect is known as multipath propagation and is particularly common in the urban environment. These replicas interfere with one another to form a signal that fluctuates as either the transmitter or the receiver or the scattering objects move. The interference effect is generally referred to as fading. These fluctuations cause the signal to frequently dip into other interfering signals, or noise, which impair reception. Higher transmission levels are then required for recovering the reception. These increase the interference to other users, and draw unnecessarily excessive transmission power.

In order to deal with multipath and fading issues, diversity techniques may be used. Diversity helps mitigate these fluctuations. Two or more receive channels are used in the BS, connected to different antenna that are either spaced from each other or polarized differently, in order to receive the signal after traversing different paths and fluctuating independently from the other. These are than optimally combined at the BS. The Mobile Station (MS), on the other hand, does not typically enjoy two receive paths and two antennas, and diversity on the down link (from the BS to the MS) has to be applied by transmitting two replicas of the signal from two antennas at the BS (called transmit diversity). These signal replicas have to be identified at the MS receiver so that a proper optimal combining can take place. CDMA systems (e.g. CdmaOne, CDMA2000, W CDMA) can apply different codes (not available to CdmaOne), or delay one of the branches by at least one transmission chip, or use phase sweeping modulation. The latter can apply to other standards too. Transmit diversity is most effective for a slow moving MS, in a non-line-of-sight environment, rich with short distance bouncing signals, a situation also called “flat fading”.

There is thus a widely recognized need for, and it would be highly advantageous to have, a base station that is able to deal with load balancing issues between sectors, and provide transmit and/or receive diversity and at the same time not give cause for municipal planning issues to be raised.

### SUMMARY OF THE INVENTION

According to one aspect of the present invention there is provided a base station for a cellular telecommunications network, the base station being arranged to support a plurality of angular sectors, each sector having two antenna columns, each column of a respective sector having elements of two polarizations, such that each polarization in each column forms a pair with a corresponding polarization in the other column, thereby to provide a phased array pair which is steerable together to form a narrow compound sector beam and steerable apart to form a wide compound sector beam.

In one embodiment the two antenna columns are provided as a single dual column antenna. Alternatively they may be provided as two single column antennas.

Preferably, a transmit diversity unit is added to at least one of the polarizations to provide transmit diversity.

Preferably, the steerability is usable to allow dynamic reconfiguration of the angular sectors.

Preferably, the transmit diversity comprises a time-delay diversity.

Preferably, the transmit diversity is provided by a phase-modulation diversity unit.

Preferably, the dynamic reconfiguration comprises dynamically controlling the angular size of each sector so that a load on the base station is spread substantially evenly between the sectors.

Preferably, the beam steering control comprises electrical tilting.

The base station typically comprises three sectors and three dual column antennas.

Alternatively, the base station may comprise three sectors and six single column antennas.

The base station may comprise a switching matrix configured to switch signals between elements thereby to provide substantial signal coverage smoothing around the base station.

The base station may comprise a power splitter for splitting an input signal into two branches for each of the polarizations.

Preferably, the power splitter is a variable power splitter.

Preferably, the variable power splitter is operable to controllably vary power between the polarizations, thereby to control the effective isotropic radiated power across the compound sector beam.

Preferably the respective polarizations within each column are orthogonal.

The base station may match the phases of the beams, thereby to eliminate interference nulls.

According to a second aspect of the present invention there is provided a base station for a cellular telephone network, the base station being modified to support a plurality of angular sectors, each sector having two antenna columns, each column being dual polarized such that each element in each column has a correspondingly polarized element in the other column, such that the correspondingly polarized elements form a phased array pair which is steerable together to form a narrow beam and steerable apart to form a wide beam.

Preferably, the two antenna columns are provided as a single dual column antenna.

Preferably, the two antenna columns are provided as two single column antennas.

The base station may comprise three sectors.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps automatically. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing unbalanced load distribution at an conventional base station;

FIG. 2 is a simplified diagram illustrating a base station that uses balanced load distribution;

FIG. 3 is a simplified block diagram showing apparatus for providing diversity and beam steering to a single sector of a base station, the sector being associated with a single dual column dual polarized antenna according to a first embodiment of the present invention;

FIG. 4 is a simplified block diagram of an arrangement for a polarization cellshaper array for a single sector, according to a variation of the embodiment of FIG. 3;

FIG. 5 is a simplified block diagram of a three-sector arrangement of the polarization Cellshaper of FIGS. 3 and 4 according to a preferred embodiment of the present invention.

FIG. 6 is a simplified diagram illustrating a beam rosette for a three sector base station according to a preferred embodiment of the present invention;

FIG. 7 is a simplified diagram illustrating a six-face Cellshaper with revolving switching matrix;

FIG. 8 is a simplified diagram showing in greater detail the variable power divider 107 of FIG. 7;

FIGS. 9A to 9D show examples of switching elements for use in the embodiment of FIG. 7;

FIG. 10 is a simplified diagram illustrating the beam rosette formed by the embodiment of FIG. 7;

FIG. 11 is a block diagram showing a single sector of a polarization based cell shaper according to a second embodiment of the present embodiment which uses beam smoothing by two polarizations;

FIG. 12 is a simplified block diagram illustrating a variation of the embodiment of FIG. 11 in which a Six Face Polarization cell shaper utilizes beam-smoothing by dual polarization; and

FIGS. 13-17 are simplified block diagrams illustrating modifications to be made to different kinds of base stations to apply the present embodiments thereto.

### DESCRIPTION OF THE PREFERRED EMBODIMENTS

The present embodiments provide novel apparatus and methods to produce controllable coverage shaping in a cell that enables load balancing between sectors and between cells, and in certain embodiments also provides effective transmit and receive diversities to the base station in a simple and low cost manner. U.S. patent application Ser. No. 10/470,467 referred to above discloses a configuration utilizing space diversity, by two spaced antennas in each sector, each one is a two-column phased array. The present embodiments utilize polarization diversity, and combinations of polarization and space diversity, for the same purpose. A first preferred embodiment of the present invention provides a polarization-diversity cell or sector shaper using just one antenna structure per sector. The antennal structure features two columns, and each column is dual polarized (i.e. +/−45° linear polarization). The antennas have the same polarizations in the two columns and are thus phased as a phased array pair. The result is to form two phased arrays, one for each polarization. The two phased arrays can then be steered together, to form a dual polarized narrow beam. Alternatively, the beam, and hence the sector, can be broadened by steering the two phased arrays in different directions. Transmit and receive diversity are applied between the two polarized systems. The diversity mechanisms also smooth the interference pattern otherwise generated between the two beams when not steered in the same direction.

The advantages of the above embodiment over previous art include the compact construction—a single antenna structure per sector, dimensionally similar to legacy sector antennas, and thus acceptable without special authorizations by zoning committees. Moreover—the complex of all three antennas in the cell is extremely compact. Polarization diversity is also known to be more effective in certain environments than space diversity.

In another preferred embodiment of the present invention, an array of dual polarized antennas producing a compound beam is described. In the embodiment, smoothing of the compound beam is accomplished by transmitting different polarizations to each of a plurality of constituent parts of the compound beam, which are orthogonal to each other. The embodiment is simpler to implement than the previous one. No transmit diversity is applied in this embodiment, but receive diversity can be maintained with these configurations.

Electrical tilting, applied remotely, is a useful option in the present embodiments, as described in International patent application No. PCT IB01/01881. The electrical tilting controls the distance of the coverage, and allows for balancing between the loads in adjacent cells, as well as providing continuous control of the cell boundaries under the operation of the a cell shaping apparatus with varying sector beam widths.

The principles and operation of a base station according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

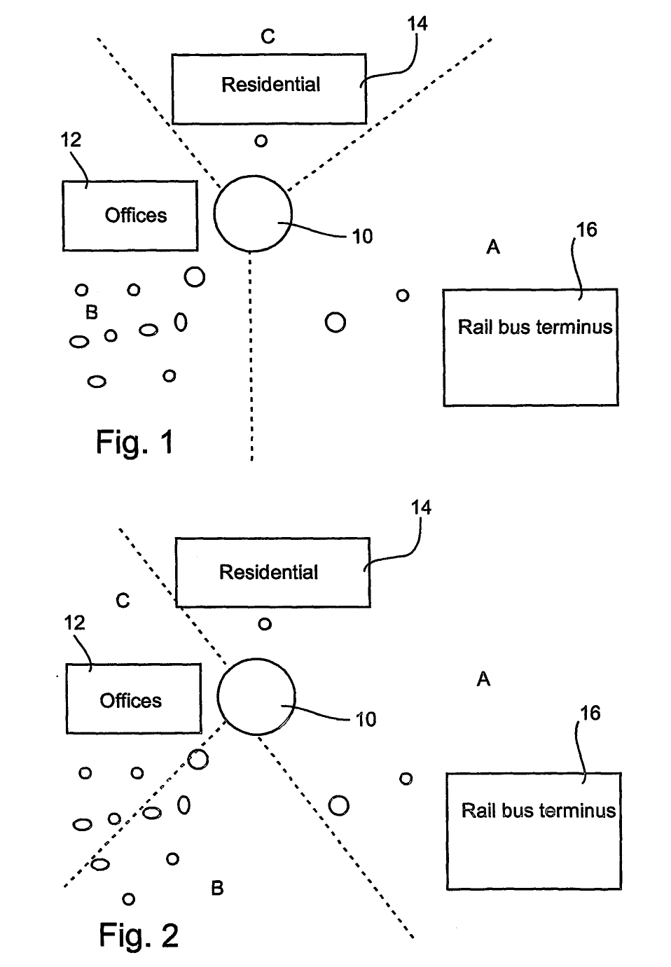

Reference is now made to FIG. 1, which is a simplified diagram illustrating a base station with fixed sectors. Base station 10 is located in an urban area and is surrounded on one side by a commercial district 12 of offices and shops. On a second side is a residential region 14 and on a third side is a major train and bus terminus. The base station 10 divides its cell into three sectors A, B, and C which are fixed. The reader will appreciate that the loading on the different sectors varies considerably depending on the time of day. The commercial district has a high loading during working hours. The rail and bus terminus has a high loading at peak travel times and the residential region has a peak load in the evening. Thus at any time of the day, base station 10 is liable to reach a state of saturation in one of its sectors, even though it actually has plenty of spare capacity. In FIG. 1, sector B is shown to have the most users.

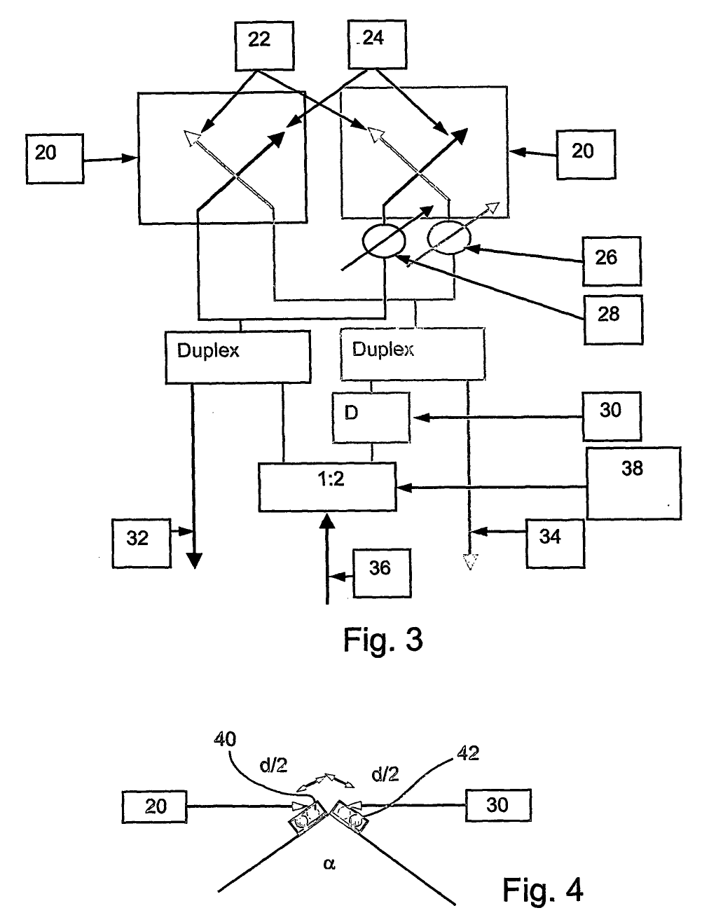

Reference is now made to FIG. 2, which is a simplified diagram illustrating the base station of FIG. 1, to which dynamic sector sizing has been applied. Parts that are the same as in previous figures are given the same reference numerals and are not referred to again except as necessary for understanding the present embodiment. In FIG. 2, sector A has expanded to fill a region combining the residential area and the travel terminus that currently has low loading, and sectors B and C between them accommodate the high loading from the commercial sector. At other times of the day, when the loading comes from other areas, the sectors are able to reconfigure themselves, so that as nearly as possible all the available capacity of the base station is used up before any sectors become saturated.

Dynamic sector sizing is known, but in the known systems, for example in U.S. patent application Ser. No. 10/470,467 to the present assignees, two antennas per sector are required. This makes the base station larger and more cumbersome, and furthermore often requires planning permission in order to modify the base station.

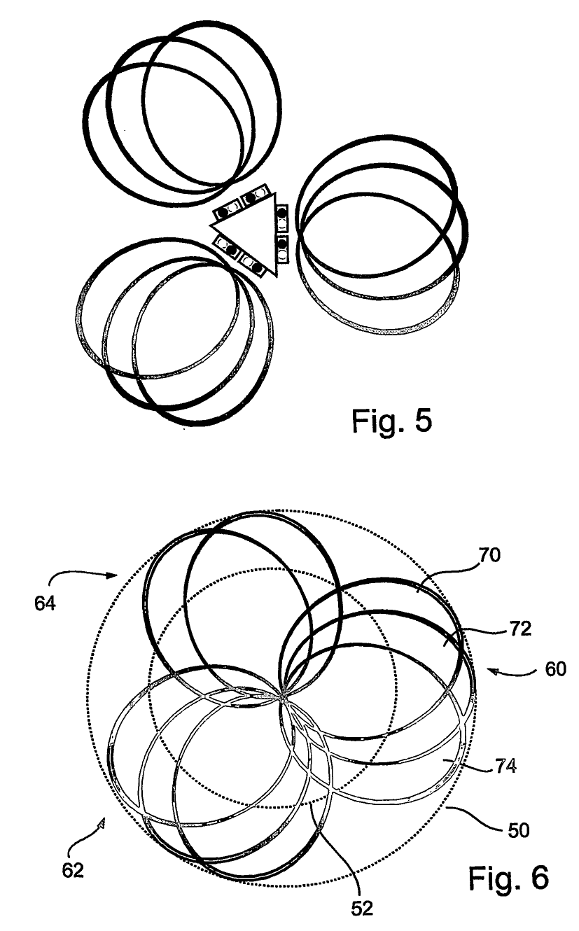

Reference is now made to FIG. 3, which is a simplified block diagram illustrating a way in which dynamic load balancing between sectors, cell shaping, can be carried out using a single dual column dual polarized antenna per sector according to a first preferred embodiment of the present invention. FIG. 3 shows an arrangement for a single sector, which is repeated several times in the base station. In the sector, a dual polarized antenna column 20 has two elements, an element 22 with a first polarization, indicated by an arrow pointing leftwards, and an element 24 with a second polarization indicated by an arrow pointing rightwards. A phase shifter 26 is provided for both of the first polarization elements, which together form a first polarized phased array.

A second phase shifter 28 is provided for the phased array formed by the second polarization elements 24.

One way of providing a phase shift is to switch between two or more phase states or delay states. Again, another embodiment involves a switch between two or more phase or delay states and can be provided as a way of providing a variable phase shifter.

A diversity unit 30 adds transmit diversity typically via either delay or phase modulation. A receive channel 32 to the base station is the main receive line—Rx Main, and a second receive channel 34 is the diversity receive line—Rx Diversity.

A transmit channel 36 from the BS may be a multi-carrier signal channel and a Splitter, or 1:2 divider 38 splits the Tx signal into main and diversity branches for transmission.

The structure of FIG. 3 is repeated for each sector in the base station, and the result is a base station that operates as a dynamic cell shaper but has just one antenna structure per sector. The antenna structure comprises two columns, and each column is dual polarized, typically ±45° linear polarizations, as indicated by leftwards and rightwards pointing arrows.

The elements of the same polarization (say 45°) in the two columns, that is the two leftwards pointing arrows and the two rightwards pointing arrows respectively, are phased as a phase-array pair resulting in a beam which can be steered by controlling the phase-shifters. The same is done for the second polarization (−45°).

Thus there are provided two beams, each having a different polarization, which can be steered independently. The two beams can thus be steered together, that is towards each other, to form a narrow dual polarized beam, or they can be steered in different directions, that is steered away from each other, to achieve a broad beam.

Rx diversity is achieved by polarization diversity.

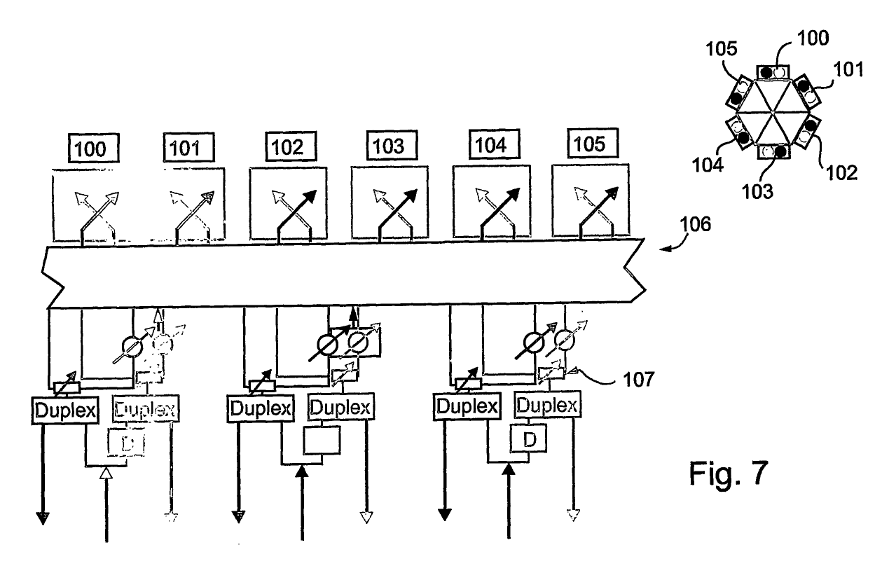

Reference is now made to FIG. 4, which shows an arrangement for a polarization cellshaper array for a single sector. Reference numeral 40 indicates a left dual (cross) polarized antenna, and reference numeral 42 indicates a right dual (cross) polarized antenna. The antennas are spaced symmetrically at a displacement d/2 from the center of the array, and at angle α. A special case is with α=180°, which provides one preferred embodiment of the array. Another special case that is of interest is that discussed in the following paragraphs, where the angle α=120°.

In the embodiment of the 180° case, that is of FIG. 4, there are two antennas which are each dual polarized. The two antennas are arranged in a compact structure, and are spaced symmetrically around the center of the array of FIG. 4, with an angle of α≦180°.

In one embodiment, a TDU or Transmit diversity unit is added to the sector. The TDU can be a Time-delay diversity unit or a Phase-modulation diversity unit, between the two polarization arrays.

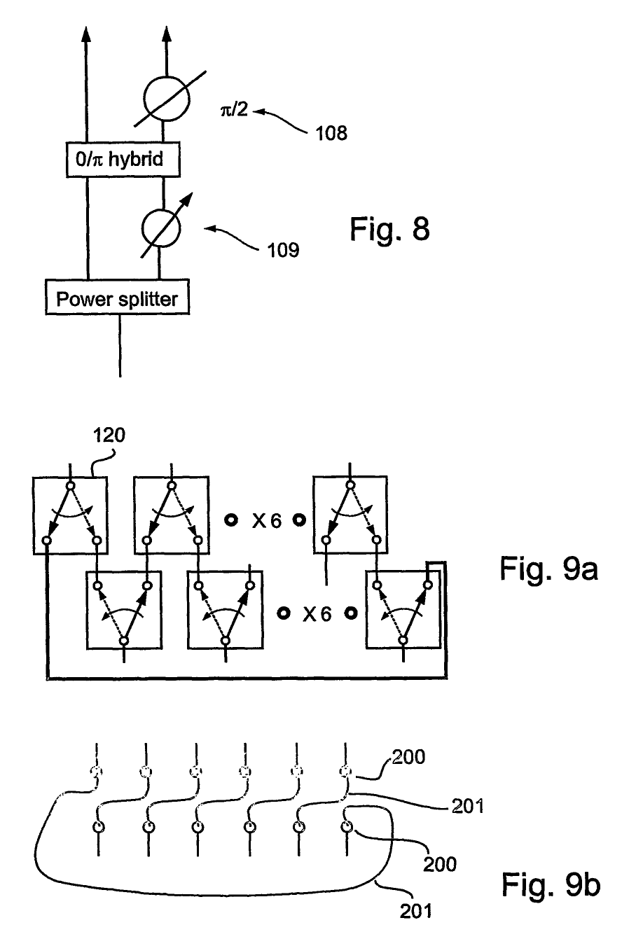

Reference is now made to FIG. 5 which shows a three-sector arrangement of the polarization Cellshaper of FIGS. 3 and 4 according to a preferred embodiment of the present invention. The structure has three faces and each face has two antennas on each face. The antennas have the same boresight, α=180°, in a preferred embodyment. Each antenna has a beamwidth of preferably 50 to 60°. By phasing the two arrays at each antenna, the boresight can squint at +/−30° without generating an appreciable grating lobe. The two arrays can be steered together, thus orienting a narrow beam between +/−30°, or can be steered in the opposite direction, thus opening a wide beam. Different combinations of wide and narrow beams generate different coverage shapes as required.

The widest beam per sector is 180°, where the beam degrades to about −10 dB to −12 dB from the peak. This level of crossover between sectors is acceptable to those acquainted with this art, and is used, for example, when beams of 60° (3 dB) illuminate sectors of 120°.

It is noted that by employing other mechanical installation configurations, with the two sector antennas slightly rotated, at a fixed azimuthal mechanical offset it is possible to extend the sector maximal angular coverage, and also to allow for handling the intersector section by employing RF switching, as will be discussed in greater detail below.

It is further noted, that in the embodiment of FIG. 5, no space diversity is employed. Consequently the total size of the arrangement of a 3-sector antenna is very compact.

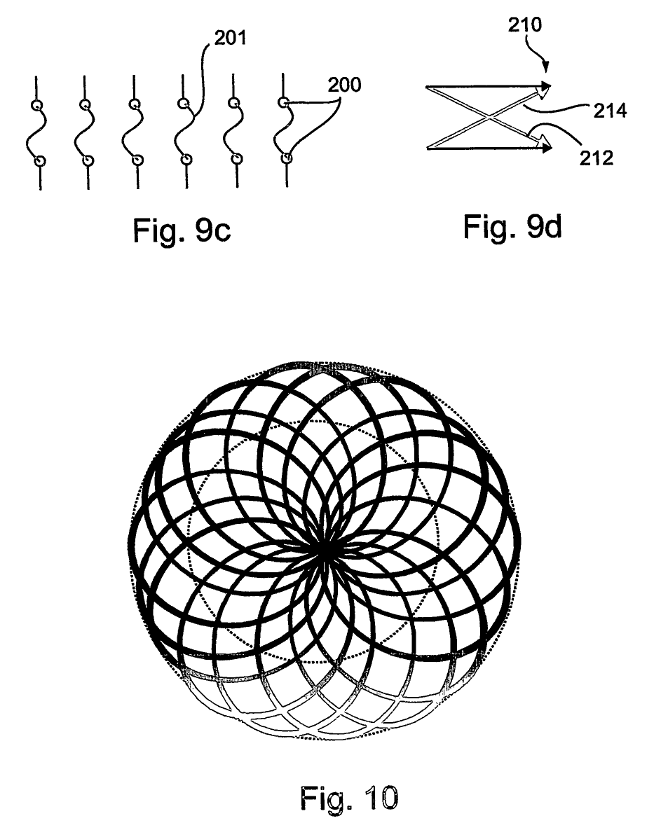

Reference is now made to FIG. 6 which shows a beam rosette for a three sector base station. FIG. 6 is the arrangement of FIG. 5 with α=180°. Dotted lines 50 and 52 indicate 0 and −3 dB relative directivity, respectively.

Each sector produces one beam set, 60, 62 and 64 respectively. Each beam set comprises three possible directions 70, 72 and 74 (in azimuth) of the first or second polarization. Each narrow beam can be steered to any direction between the two extreme beams 70 and 74. The steering can be done independently for each polarization. If the two beams are steered together (pointing in the same direction) we get a compound narrow beam. If they are steered in different directions we get a compound wider beam, which spans the space between the two extreme beams 70 and 74.

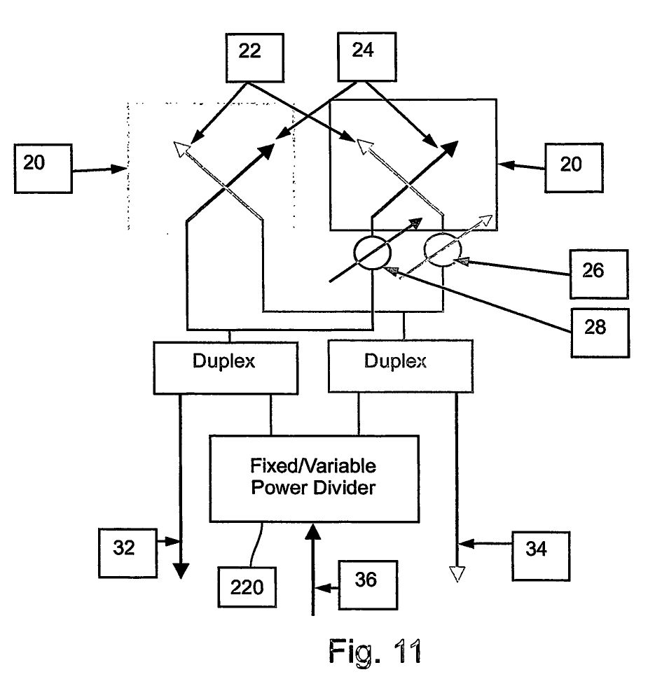

Reference is now made to FIG. 7, which shows a six-face Cellshaper with revolving switching matrix. In FIG. 7, elements 100-105 are dual pole antennas. The dual pole antennas are shown as part of the base station physical configuration—top, and as part of the logical configuration—below. A revolving switching matrix 106 connects up the antennas and variable power dividers 107 link the channels to the switching matrix. The configuration of FIG. 7 offers smoother coverage around the cell. In the embodiment of FIG. 7, α=120°.

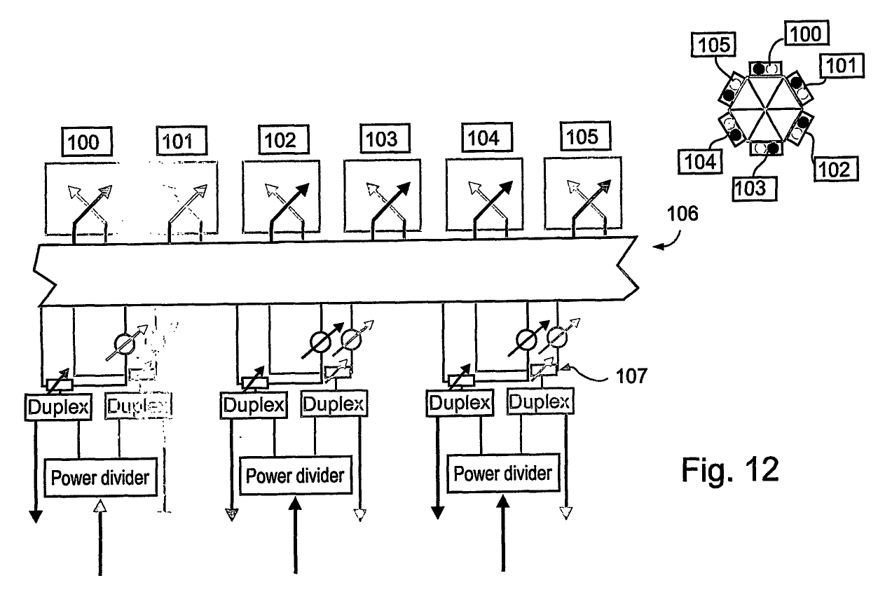

Reference is now made to FIG. 8 which shows one possibility for the variable power divider 107 of FIG. 7. As shown in FIG. 7, it is possible to add a variable power divider between the arrays. The variable power divider comprises a fixed π/2 phase shifter 108, which can be combined with the variable phase shifter 109.

The above network is a high-power low-loss RF network that covers the operating frequency band of a typical operator, and thus provides a flat characteristic over all the carriers employed by the operator.

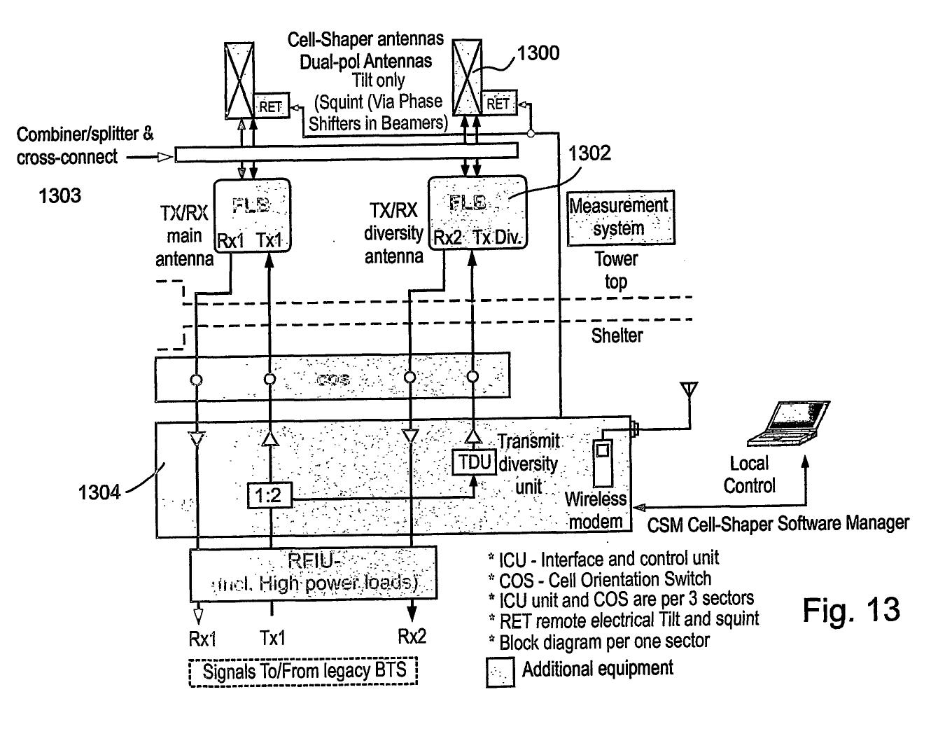

Reference is now made to FIG. 9A, which shows in greater detail one embodiment of the revolving switching matrix 106 of FIG. 5. The matrix comprises a plurality of switching elements 120. Two such matrices are required, one for each of the two phased arrays. The matrices may be connected by adding a cross-connect switch between arrays.

Instead of a revolving switching matrix it is possible to use an interconnect matrix. An interconnect matrix is shown in a first state A in FIG. 9B and a second state B in FIG. 9C. The interconnect matrix uses interconnectors 200 and RF cables 201 rather than switching elements. Again, two such matrices are required: one for each phase. The interconnectors are arranged columnwise in two rows. In state A, the interconnectors in the bottom row are connected to the interconnectors adjacent on one side in the row above. The end connector at the left hand side in the top row is connected to the end connector at the right hand side in the bottom row. In state B interconnectors in the bottom row are connected to the interconnectors directly above.

The skilled person will be aware that alternative switch architectures are possible for additional flexibility, depending on the detailed realization block diagram of the cell shaping system.

In an Add-On configuration, one transmit branch uses the Tx power from the legacy BTS amplifier, whereas the other (e.g. diversity) branch uses an additional outdoor beamer unit. The beamer is an outside unit located near the antenna. The unit comprises a power amplifier, and in the present case a phase shifter, on the transmit direction and a Low Noise Amplifier in the receive direction. There is preferably a duplexer on the antenna side to separate the transmit and receive branches.

Some configurations use dual beamers which have two amplifiers in the transmit path The amplifier is preferably connected to an in-shelter ICU unit which includes a variable controlled attenuator and/or phase-shifter. In such applications it may be advantageous to have the capability to cross connect (switch) the two sector antennas so that the controllable amplitude and/or phase is applied to the other branch. A suitable cross connect switch is shown in FIG. 9D. In FIG. 9D straight connections 212 are regular direct connections and diagonal connections 214 provide the cross connection. Connections from the base stations to the antennas is carried out either by via the direct or the diagonal connections independently for each sector.

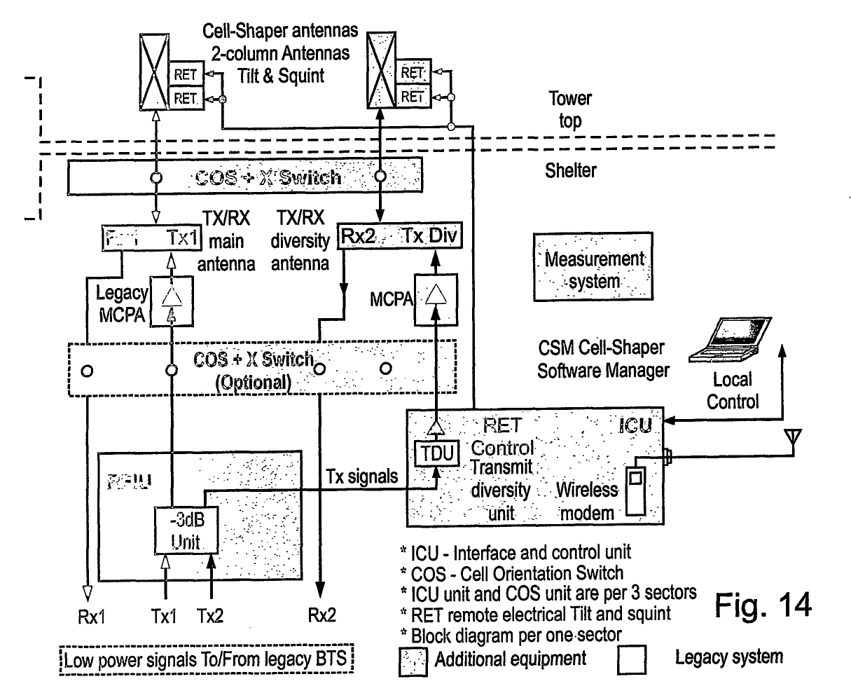

Reference is now made to FIG. 10 which shows the beam rosette that is produced by the configuration of FIG. 7. In the case of α=180° and using a squint of +/−30° the beam rosette that is produced is that shown in FIG. 6. However, by using the six-face cell shaper (α=120°) of FIG. 7 together with switching matrix 106, the angular range over which the beams can be steered is increased and the result is a rosette with more flexible coverage.

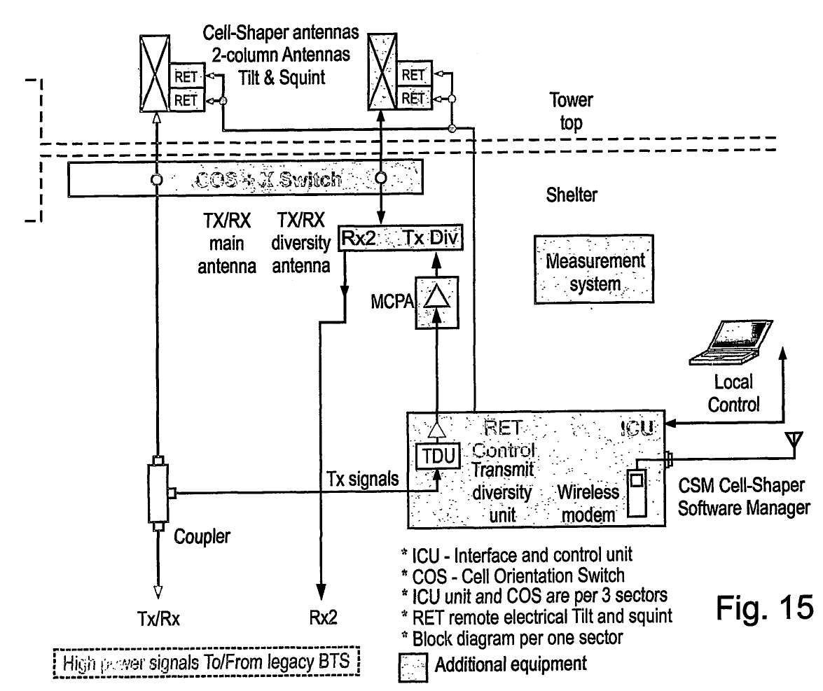

Reference is now made to FIG. 11 which is a block diagram showing a single sector of a polarization based cell shaper according to a second embodiment of the present embodiment which uses beam smoothing by two polarizations. Parts that are the same as in FIG. 3 are given the same reference numerals and are not described again except as necessary for an understanding of the present embodiment.

The embodiment of FIG. 11 does not include the diversity element or TDU 30 of the embodiment of FIG. 3 but it does include a fixed/variable Power divider 220. The fixed variable power divider 220 is connected between input 36 from the base station and the duplexers of the respective phases.

The polarization of the transmit signal is indicated by the right and left slants of the arrows in each beam. In case the beams are overlapping, as in the case when both phase shifters 26 and 28 have the same value, the resulting transmit polarization is vertical. Care has to be taken to match the phases of the two transmission branches from the split point to the phase shifters 26 and 28. When broadening the beam by applying different squint to the two phase shifters, the ensuing polarization of the signals transmitted in directions between the boresights of the “red” and the “blue” beams becomes elliptical. This eliminates adverse interference nulls that are created otherwise between two coherent and identically polarized beams.

The power splitter 220 is an equal power divider in one embodiment. The differentially polarized beams thus generated have equal strength, or equal effective isotropic radiated power (EIRP) in this case. By replacing the equal power divider with a variable power divider however, an additional degree of control is gained. Such a variable power divider allows for EIRP control across the compound beam. One preferred embodiment of variable power divider is that described above with respect to FIG. 8.

The following documents are relevant to the embodiment of FIG. 11:
1. Y. Yamada, M. Kijima: “A slender two Beam Base Station Antenna for Mobile Radio”, Proceedings of IEEE Antennas and Propagation Society Symposium, June 1994, pp. 352-355.
2. Y. Elbine, M. Ito: “Design of a Dual Beam Antenna used for Base Station of Cellular Mobile Radios”, IEICE Trans. Communications, Vol. J79-B-II, No. 11, November 1996, pp. 909-915.

Note that the antenna described in the above two papers have two separate beams as in the embodiment of FIG. 11 but the beams are not combined and the embodiments use only vertical polarization, unlike the embodiment of FIG. 11, which uses two orthogonal polarizations.

The embodiment of FIG. 11 uses two orthogonal polarizations for the two beams, and the use of such orthogonal polarizations allows for tier combining while avoiding the interference nulls. This does not appear in the prior art, nor is it an obvious development therefrom.

The embodiment of FIG. 11 provides a simpler device than that described in the preceding embodiments since it does not require a TDU. In the simplified device, smoothing of the compound beam is accomplished by transmitting different polarizations in each beam. The polarizations are orthogonal to each other, and care is preferably taken to match the phases of the two transmission branches from the split point to the phase shifters. The matching eliminates adverse interference nulls that that are created otherwise between two coherent and identically polarized beams.

In the embodiment, tilt control is preferably added to allow control of the beam angles. Again, measurement and control systems are preferably provided, which may be locally or remotely controlled as required.

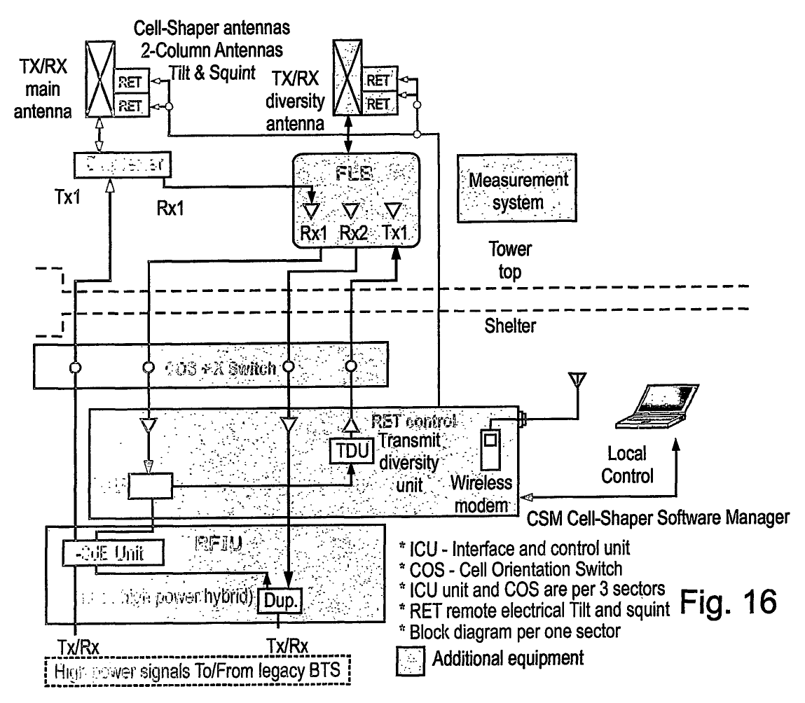

Reference is now made to FIG. 12 which is a simplified schematic diagram showing a Six Face Polarization cell shaper with beam-smoothing by dual polarization. Parts that are the same as in previous figures are given the same reference numerals and are not referred to again except as necessary for understanding the present embodiment. The preferred array configurations and beam forming for the embodiment of FIG. 12 are preferably the same as those described with respect to FIGS. 7-10. The figure shows a CellShaper with a three sector arrangement (α=120°). The cell is preferably controlled using revolving switching matrix 106 as described above, which offers smooth coverage around the cell. FIGS. 9A-C provide different embodiments of the switching matrix, which are suitable for the present embodiment.

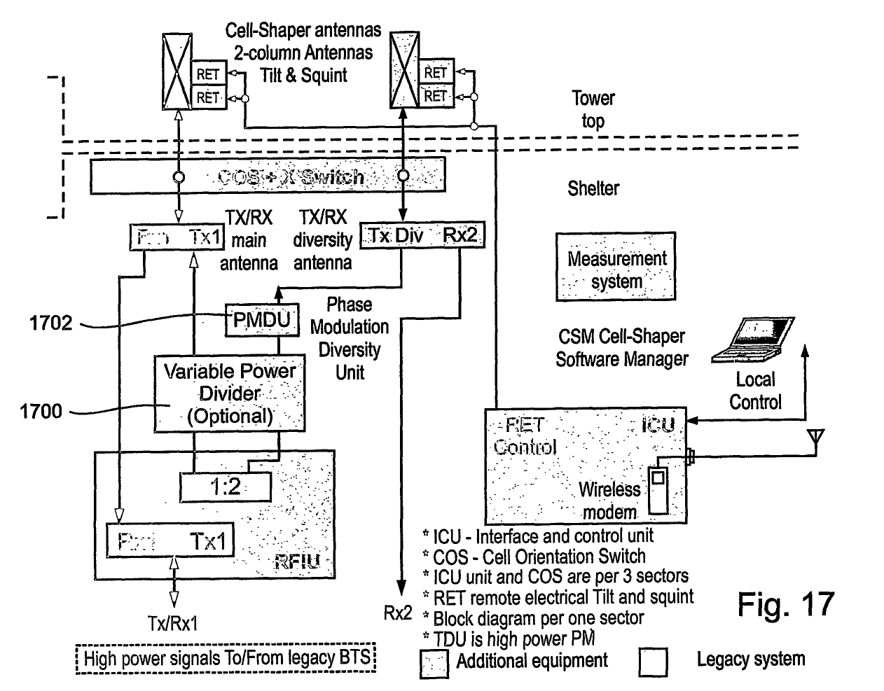

FIGS. 13-18 provide examples of practical implementations and configurations with various base station types and various interfaces. That is to say they give examples of how to provide polarization-based cell shaping and transmit diversity features as add-ons to existing base stations. Preferably the add-on operation uses closely spaced dual polarization antennas so as not to give rise to the need for planning applications as explained.

In particular the implementations present the optional realization of squint control via phase shifters implemented within the antenna array and remotely controlled via electric RET control. Alternatively, the squint phase shifters may reside externally of the antennas and be controlled in a standard or proprietary manner. This second option allows for standard dual-polarized antennas to be used in embodiments of the present invention.

In the internal antenna phase shifter implementation, there are two possible embodiments, each relying on two types of antennas: 1) A single-phase shifter per antenna—on right polarized or on left polarized antenna 2) An antenna with two phase-shifters and an antenna with no phase-shifter. Each of the figures is a diagram for a single sector.

Reference is now made to FIG. 13 which shows standard dual-polarization antennas 1300, and in which squint control is performed using phase shifters within dual Beamers (FLB) 1302. Transmit diversity is provided using a transmit diversity unit TDU 1304. The beamers 1302 are connected to antennas 1300 via a combiner splitter & cross-connect unit 1303.

Reference is now made to FIG. 14, which is a simplified diagram illustrating an implementation for a legacy base station which has Tx1, and Tx2 channels for 2 groups of carriers. The channels are combined and split to achieve Tx diversity.

The cell orientation switch (COS) and X switches may be high power or low power as desired.

Reference is now made to FIG. 15, which illustrates a configuration for a high power signal from the base station. The embodiment is thus distinguished in there being no high power amplifier (HPA) in the main transmission path.

Reference is now made to FIG. 16, which again illustrates a configuration for a high power signal from the base station. Two groups of carriers from Base (Tx1 Tx2) are combined and split to obtain transmit diversity, as with the embodiment of FIG. 14.

Reference is now made to FIG. 17, which is a configuration in which a high power signal is received from a base station, and which includes a variable power divider 1700 and a high power PMDU (phase modulation diversity unit) 1702. PMDU is applicable to CDMA but also to other cellular systems such as GSM, and TDMA.

It is expected that during the life of this patent many relevant cellular technologies and systems will be developed and the scope of the terms herein, particularly of the term “base station”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A base station for a cellular telecommunications network, said base station being arranged to support a plurality of angular sectors, each sector having two antenna columns, each column of a respective sector having elements of two polarizations, such that each polarization in each column forms a pair with a corresponding polarization in the other column, thereby to provide a phased array pair which is steerable together to form a narrow compound sector beam and steerable apart to form a wide compound sector beam.

2. The base station of claim 1, wherein said two antenna columns are provided as a single dual column antenna.

3. The base station of claim 1, wherein said two antenna columns are provided as two single column antennas.

4. The base station of claim 1, wherein a transmit diversity unit is added to at least one of said polarizations to provide transmit diversity.

5. The base station of claim 1, wherein said steerability is usable to allow dynamic reconfiguration of said angular sectors.

6. The base station of claim 4, wherein said transmit diversity comprises a time-delay diversity.

7. The base station of claim 4, wherein said transmit diversity is provided by a phase-modulation diversity unit.

8. The base station of claim 5, wherein said dynamic reconfiguration comprises dynamically controlling the angular size of each sector so that a load on said base station is spread substantially evenly between said sectors.

9. The base station of claim 1, wherein said beam steering control comprises electrical tilting.

10. The base station of claim 1, comprising three sectors and three dual column antennas.

11. The base station of claim 3, comprising three sectors and six single column antennas.

12. The base station of claim 11, further comprising a switching matrix configured to switch signals between elements thereby to provide substantial signal coverage smoothing around said base station.

13. The base station of claim 1, comprising a power splitter for splitting an input signal into two branches for each of said polarizations.

14. The base station of claim 13, wherein said power splitter is a variable power splitter.

15. The base station of claim 14, wherein said variable power splitter is operable to controllably vary power between said polarizations, thereby to control the effective isotropic radiated power across said compound sector beam.

16. The base station of claim 1, wherein respective polarizations within each column are orthogonal.

17. The base station of claim 16, comprising matching the phases of said beams, thereby to eliminate interference nulls.

18. A base station for a cellular telephone network, the base station being modified to support a plurality of angular sectors, each sector having two antenna columns, each column being dual polarized such that each element in each column has a correspondingly polarized element in the other column, such that said correspondingly polarized elements form a phased array pair which is steerable together to form a narrow beam and steerable apart to form a wide beam.

19. The base station of claim 18, wherein said two antenna columns are provided as a single dual column antenna.

20. The base station of claim 18, wherein said two antenna columns are provided as two single column antennas.

21. The base station of claim 20, comprising three sectors.
